(19) United States
(12) Patent Application Publication
(10) Pub. No.: US 2019/0352219 A1
(43) Pub. Date: Nov. 21, 2019

(54) GLASS COMPOSITION CO-FIREABLE WITH TITANIA FOR SEALING LARGE-AREA DYE-SENSITIZED SOLAR CELL

(71) Applicants: ORION CO., LTD., Gumi-si (KR); KONGJU NATIONAL UNIVERSITY INDUSTRY-UNIVERSITY COOPERATION FOUNDATION, Gongju-si (KR)

(72) Inventors: Woon Jin CHUNG, Cheonan-si (KR); Han Sol LEE, Daejeon (KR); Jae Kwun HWANG, Gumi-si (KR); Jae Hyoung PARK, Gumi-si (KR)

(21) Appl. No.: 16/321,694

(22) PCT Filed: Jul. 28, 2017
(86) PCT No.: PCT/KR2017/008160

§ 371 Date: Jan. 29, 2019

(30) Foreign Application Priority Data
Jul. 29, 2016 (KR) 10-2016-0097361

(51) Int. Cl. C03C 8/24; C03C 8/08; H01G 9/20

(52) U.S. Cl. CPC C03C 8/24; H01G 9/2077; C03C 8/08

(57) ABSTRACT

The present invention relates to a glass material for sealing a large-area dye-sensitized solar cell and, more specifically, to a glass material capable of binding to a large area uniformly and very strongly without reacting with en electrolyte. According to the present invention as described above, the glass material is expected to have effects of uniformly sealing a dye-sensitized solar cell, securing stable chemical properties against a reaction with an electrolyte, and having physical strength suitable for large-area binding, and thus can improve reliability and lifetime of solar cell products.

### DESCRIPTION OF GOVERNMENT-FUNDED RESEARCH AND DEVELOPMENT

This research was conducted by Orion Co., Ltd. under the support of the Korea Technology & Information Promotion Agency for SMEs of the Small and Medium Business Administration (Option-to-purchase new product development project; Development of glass frit material for sealing large-area DSSC; Project serial number: 1425097431).

### TECHNICAL FIELD

The present disclosure relates to a glass material for sealing a large-area dye-sensitized solar cell, more specifically, to a glass material capable of binding to a large area uniformly and very strongly without reacting with an electrolyte.

### BACKGROUND ART

A dye-sensitized solar cell, which is said to be a next-generation solar cell, is a semi-permanent solar cell developed by using a dye which is a polymer material to produce and absorb electrons, and recently, it is gaining attentions as a new environment-friendly renewable energy source. The dye-sensitized solar cell uses a transparent glass substrate and can freely display colors according to the type of the dye and thus has an aesthetic value. In addition, since it can be made into different sizes, it is expected to be easily used over a wide range of applications and is of high use.

However, because efficiency is still low at the current level of development, it is not fully used in all possible applications, and large-area dye-sensitized solar cells are produced on a trial basis and some are being used for interior applications on windows or walls. Accordingly, the potential for the development of dye-sensitized solar cells is high and, in this context, fabrication of dye-sensitized solar cells with large area is an important factor of development.

In addition to a dye, the dye-sensitized solar cell uses an electrolyte as an electron transport channel, and liquid electrolytes of differ components are used depending on the type of the dye. For electrolyte impregnation, a partition wall is needed to prevent the electrolyte from leaking and DuPont's Surlyn™ film, which is a polymer material, has been used as a conventional sealing material for a dye-sensitized solar cell.

However, the Surlyn film has limitations in that it has weak mechanical durability, is difficult to achieve precise binding because it is of film type, and is prone to reaction with oxygen or water due to the properties of the organic material. Particularly, to achieve large area, precise bonding and high physical durability for maintaining adhesion to a large-area substrate is required. But, the Surlyn film is difficult to satisfy these requirements.

For this, glass is used to ensure physical durability and screen printing is performed using a paste to allow uniform bonding by a frit. Furthermore, the reactivity of glass with an electrolyte needs to be minimized in order to ensure chemical durability. For this, it is necessary to exclude the inclusion of alkalis and transition metals.

On the other hand, TiO₂ is used as an electron transport material of a dye-sensitized solar cell. But, TiO₂ shows change in crystal structure depending on the phase. Because the phase having the greatest electron transport ability experiences phase transition at 550° C., for a glass composition that can be used at 550° C. or below is necessary.

There are results of studies using commercialized glasses such as borosilicate or soda-lime as a sealing material. But, frit formation is difficult due to high process temperature, and thus, uniform bonding is not easy. Furthermore, there were instances of using a laser to replace the high process temperature. But, because precise laser control is difficult, it is difficult to achieve uniform bonding. Moreover, the commercialized glass compositions include some alkali elements and transition metals, and this causes a problem as well.

### DISCLOSURE

### Technical Problem

The present disclosure is designed to solve the aforementioned problems, and therefore the present disclosure is directed to providing a glass composition for sealing a large-area dye-sensitized solar cell, which has chemical stability and physical durability and exhibits strong adhesion.

### Technical Solution

To achieve the aforementioned object, the present disclosure provides a glass composition for sealing a dye-sensitized solar cell, which contains a (P₂O₅+ZnO)—V₂O₅—TeO₂ based glass composition, wherein (P₂O₅+ZnO) is present in 50 to 65 mol %, V₂O₅ is present in 30 to 45 mol %, TeO₂ is present in 5 to 20 mol %, V₂O₅/TeO₂ has a value of 2 to 6 based on a molar ratio, and at least one selected from Al₂O₃, B₂O₃ and Sb₂O₃ is contained in an amount more than 0 mol % and less than or equal to 10 mol %.

Specifically, the at least one selected from Al₂O₃, B₂O₃ and Sb₂O₃ may partly replace the (P₂O₅+ZnO).

Specifically, the composition may have a firing temperature of 400 to 500° C.

Furthermore, the present disclosure provides a paste for sealing a dye-sensitized solar cell, which contains the glass composition; and an organic vehicle.

### Advantageous Effects

According to the present disclosure as described above, effects are expected to uniformly seal a dye-sensitized solar cell, secure stable chemical properties against a reaction with an electrolyte and have physical strength suitable for large-area binding. Therefore, an effect of improving the reliability and lifetime of solar cell products is expected.

In addition, because a glass for sealing a dye-sensitized solar cell according to the present disclosure has the same firing temperature as the firing temperature set when manufacturing the unit cells of a dye-sensitized solar cell, there is no need to separately perform a sealing process. Therefore, the process can be simplified and a mass production system can be established easily.

Furthermore, the glass for sealing a dye-sensitized solar cell according to the present disclosure does not need any separate limitation on environment, leading to a wide of selections of process applications.

Furthermore, because the glass can be fired at 500° C. or below, it is expected to produce the effects of preventing damage of an electrolyte and an electrode and deformation of a substrate that may occur when fabricating a dye-sensitized solar cell at high temperature.

### BRIEF DESCRIPTION OF DRAWING

FIG. 1 is a phase diagram of a three-component system based on observations of a formation region of (P₂O₅+ZnO)—V₂O₅—TeO₂ based glass.

### MODE FOR CARRYING OUT INVENTION

Hereinafter, the embodiments of the present disclosure are described in detail with reference to the accompanying drawing. The embodiments disclosed below are provided for illustrative purposes to give a full understanding of the present disclosure to those having ordinary skill in the technical field to which the present disclosure belongs. Therefore, the present disclosure is not limited to the disclosed embodiments and may be embodied in other different forms.

First, a glass composition for sealing a dye-sensitized solar cell according to an exemplary embodiment of the present disclosure is described in detail.

In the present disclosure, firing temperature refers to the temperature for softening or metaling a glass composition during a sealing process.

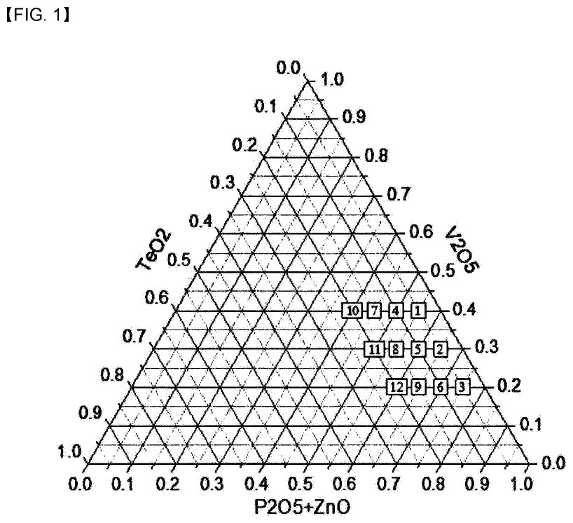

FIG. 1 shows is a phase diagram of a three-component system (P₂O₅+ZnO)—V₂O₅—TeO₂ based glass and a glass composition according to an exemplary embodiment of the present disclosure.

The glass composition for sealing a dye-sensitized solar cell contains (P₂O₅+ZnO)—V₂O₅—TeO₂ based glass, and the (P₂O₅+ZnO)—V₂O₅—TeO₂ based glass may contain 50 to 65 mol % of (P₂O₅+ZnO), 30 to 40 mol % of V₂O₅ and 5 to 20 mol % of TeO₂.

The glass for sealing a dye-sensitized solar cell having the above component ratio is not susceptible to crystallization and phase separation, and because it does not contain alkali elements and transition metals that react with an electrolyte, it is not reactive with an electrolyte, and thus, is chemically stable, and it is physically strong due to high binding strength, and can be fired at the same temperature as the firing temperature of the dye-sensitized solar cell, facilitating the process.

The main cause of the high binding strength is sufficient flowability possessed due to low firing temperature as compared to other glass compositions, and can be further explained by the fact that additional components added in small amounts such as Al₂O₃, B₂O₃, Sb₂O₃, etc. control the thermal expansion coefficient to be similar to the thermal expansion coefficient of a substrate.

And, the main cause of the low firing temperature is the use of V₂O₅ and P₂O₅. It is because the conventional three-component system corresponds to materials all involved in having low temperature. To be more specific, V₂O₅ and P₂O₅ form a weak glass network structure and ZnO and TeO₂ act to connect V₂O₅ to P₂O₅ between the two materials.

The firing temperature of the (P₂O₅+ZnO)—V₂O₅—TeO₂ based glass may be 500° C. or lower, specifically 400 to 500° C. If the firing temperature is below 400° C., the fluidity and flowability of the glass composition may be low to some extent.

In the glass composition for sealing a dye-sensitized solar cell, the (P₂O₅+ZnO) may form a 2-dimensional or 3-dimensional basic structure in the glass as one of glass network formers. Glass containing the (P₂O₅+ZnO) may have superior fluidity of P₂O₅ and superior physically and chemically stable properties of ZnO at the same time when P₂O₅ and ZnO are combined at a specific ratio, as compared to glasses to which only P₂O₅ or ZnO is added. P₂O₅ has high fluidity due to low firing temperature as a weak glass network structure is formed in the glass. Therefore, the glass composition has low physical and chemical stability. ZnO forms a stronger bond than P₂O₅. It serves as a structure connector and former at the same time. When ZnO is combined with P₂O₅ at a specific ratio, both properties may be superior.

Specifically, the (P₂O₅+ZnO)—V₂O₅—TeO₂ based glass according to an exemplary embodiment of the present disclosure may contain 50 to 65 mol % of (P₂O₅+ZnO). If the (P₂O₅+ZnO)—V₂O₅—TeO₂ based glass contains the (P₂O₅+ZnO) in an amount less than 50 mol %, firing may be difficult due to decreased fluidity. And, if (P₂O₅+ZnO) is contained in an amount exceeding 65 mol %, chemical durability may be weak due to increased wettability. Accordingly, the above-described numerical range of the content of (P₂O₅+ZnO) has critical significance.

In the glass composition for sealing a dye-sensitized solar cell, V₂O₅ may serve as a network modifier to break the network structure, but a large amount of V₂O₅ may form a glass structure together with a certain amount of P₂O₅. Furthermore, the V₂O₅ acts to lower the firing temperature of glass, thereby facilitating the firing, and reduce the thermal expansion coefficient.

Specifically, the (P₂O₅+ZnO)—V₂O₅—TeO₂ based glass according to an exemplary embodiment of the present disclosure may contain 30 to 40 mol % of V₂O₅.

When the P₂O₅—V₂O₅—(Sb₂O₃+ZnO) based glass contains less than 30 mol % of V₂O₅, wettability increases and the chemical durability of glass is decreased due to the relatively high fraction of P₂O₅. And, when the (P₂O₅+ZnO)—V₂O₅—TeO₂ based glass contains more than 40 mol % of V₂O₅, the glass material to be produced may be physically weak or the firing temperature may be too low. Accordingly, the above-described numerical range of the content of V₂O₅ has critical significance.

In the glass composition for sealing a dye-sensitized solar cell, TeO₂ is used as a portion of a network modifier. When TeO₂ is present in small amounts, it serves as a network former of the (P₂O₅+ZnO)—V₂O₅—TeO₂ based glass, thereby lowering the firing temperature of glass. Also, it may enhance bonding with the substrate through control of the thermal expansion coefficient. As the content increases, the softening point increases and the viscosity increases, causing phase separation and crystallization of glass.

Specifically, the (P₂O₅+ZnO)—V₂O₅—TeO₂ based glass according to an exemplary embodiment of the present disclosure may contain 5 to 20 mol % of TeO₂.

When the (P₂O₅+ZnO)—V₂O₅—TeO₂ based glass contains less than 5 mol % of TeO₂, the physical and chemical stability of glass is decreased. And, chemically, a reaction with oxygen, air or an electrolyte occurs, and physically, the crosslinking role of P₂O₅ and V₂O₅ is weakened, causing a problem with durability, which makes it difficult to be used as a glass material. In contrast, when TeO₂ is contained in an amount exceeding 20 mol %, there are disadvantages that the viscosity of glass increases, leading to insufficient flowability at the temperature of 500° C. or below and making firing difficult, which may cause phase separation and crystallization of the glass material. Accordingly, the above-described numerical range of the content of TeO₂ has critical significance.

The glass composition for sealing a dye-sensitized solar cell according to an exemplary embodiment of the present disclosure may further contain, in addition to the (P₂O₅+ZnO)—V₂O₅—TeO₂ based glass, at least one selected from Al₂O₃, B₂O₃ and Sb₂O₃ in an amount more than 0 mol % and less than or equal to 10 mol %. The at least one selected from Al₂O₃, B₂O₃ and Sb₂O₃ may partly replace the (P₂O₅+ZnO).

Although the Al₂O₃, B₂O₃ and Sb₂O₃ may increase or decrease softening point by strengthening or weakening the network structure in the P₂O₅—V₂O₅—(Sb₂O₃+ZnO) based glass, they may serve to improve adhesion strength, chemical and physical stability, etc. When the Al₂O₃, B₂O₃ and Sb₂O₃ are contained in an amount exceeding 10 mol %, the firing temperature may be increased or decreased significantly due to the structural change of glass or phase separation and crystallization may occur.

Specifically, the glass composition for sealing a dye-sensitized solar cell according to an exemplary embodiment of the present disclosure may not further contain an additional transition metal such as Cr, Fe, Co, Ni, Mo or Bi. The transition metal may cause precipitation and elution in a dye-sensitized solar cell by reacting with an electrolyte. This may be the cause of reducing the durability of the glass for sealing a dye-sensitized solar cell.

The sealing of the dye-sensitized solar cell binds two substrates and the electrolyte used acts to block the contact with air, water and other contaminants. As the existing sealing material, the synthetic polymer material called Surlyn film is used. Although the film achieves stable binding and sealing for a single cell, as areas become larger, the binding strength becomes low and a process for uniform binding is unfavorable, and a contact area with oxygen or moisture increases and the reaction with an electrolyte is increased, making it difficult to use.

Accordingly, by using the glass appropriate for sealing a large-area dye-sensitized solar cell as a sealing material, physical durability can be improved and chemical and thermal durability can be ensured as compared to when the Surlyn film is used.

This glass can be used as a paste material for sealing a dye-sensitized solar cell, together with an organic vehicle.

Hereinafter, a glass manufacturing method according to another exemplary embodiment of the present disclosure is described in detail.

A method for preparing glass according to another exemplary embodiment of the present disclosure includes mixing 50 to 65 mol % of (P₂O₅+ZnO), 30 to 40 mol % of V₂O₅ and 5 to 20 mol % of TeO₂ with an organic vehicle and firing at a predetermined firing temperature. The firing includes, but not limited to, molding the glass and the vehicle by heating, and for example, may be performed by processes including a screen printing process.

In addition, the firing may be also performed by various other methods. Subsequently, the molded glass and vehicle are molded by heating and melting at the predetermined firing temperature, and then cooled to complete the sealing process.

Because the glass does not contain alkali elements and additional transition metals such as Cr, Fe, Co, Ni, Mo or Bi, a maximum of reactable factors of the glass with an electrolyte is obviated. Therefore, high chemical and mechanical stability are achieved as elution and precipitation reactions are prevented.

When the Al₂O₃, B₂O₃ and Sb₂O₃ replace (P₂O₅+ZnO), the glass phase is stabilized, and it is possible to control the fluidity at a predetermined temperature. Accordingly, the process applicability can be improved by including the Al₂O₃, B₂O₃ and Sb₂O₃ in the (P₂O₅+ZnO)—V₂O₅—TeO₂ based glass.

Hereinafter, specific examples according to the present disclosure are described in detail with reference to a drawing.

### EXAMPLE

(P₂O₅+ZnO)—V₂O₅—TeO₂ based glass was weighted for each sample according to the composition shown in Table 1. Although Al₂O₃ was selected from Al₂O₃, B₂O₃ and Sb₂O₃ as a specific example, other materials enumerated above can replace it within the range of compositional ratios presented in the present disclosure.

TABLE 1
Unit: mol %

| Glass | | | | | | Melting | Firing | | |
|---|---|---|---|---|---|---|---|---|---|
| sample | P₂O₅ | ZnO | V₂O₅ | TeO₂ | Al₂O₃ | results | results | Note | V₂O₅/TeO₂ |
| 1 | 27.5 | 27.5 | 40 | 5 | 0 | ◯ | X | Crystallized | 8 |
| 2 | 32.5 | 32.5 | 30 | 5 | 0 | ◯ | ◯ | Superior fluidity | 6 |
| 3 | 37.5 | 37.5 | 20 | 5 | 0 | ◯ | ◯ | | 4 |
| 4 | 25 | 25 | 40 | 10 | 0 | ◯ | X | Crystallized | 4 |
| 5 | 30 | 30 | 30 | 10 | 0 | ◯ | ◯ | Superior fluidity | 3 |
| 6 | 35 | 35 | 20 | 10 | 0 | ◯ | ◯ | | 2 |
| 7 | 22.5 | 22.5 | 40 | 15 | 0 | ◯ | X | Crystallized | 2.7 |
| 8 | 27.5 | 27.5 | 30 | 15 | 0 | ◯ | ◯ | | 2 |
| 9 | 32.5 | 32.5 | 20 | 15 | 0 | ◯ | ◯ | | 1.3 |
| 10 | 20 | 20 | 40 | 20 | 0 | ◯ | X | Crystallized | 2 |
| 11 | 25 | 25 | 30 | 20 | 0 | ◯ | ◯ | | 1.5 |
| 12 | 30 | 30 | 20 | 20 | 0 | ◯ | ◯ | | 1 |
| 13 | 31.5 | 32.5 | 30 | 5 | 1 | ◯ | ◯ | | 6 |
| 14 | 29.5 | 32.5 | 30 | 5 | 3 | ◯ | ◯ | Superior physical | 6 |
| | | | | | | | | properties | |
| 15 | 27.5 | 32.5 | 30 | 5 | 5 | ◯ | ◯ | | 6 |
| 16 | 29 | 30 | 30 | 10 | 1 | ◯ | ◯ | | 3 |
| 17 | 27 | 30 | 30 | 10 | 3 | ◯ | ◯ | Superior physical | 3 |
| | | | | | | | | properties | |
| 18 | 25 | 30 | 30 | 10 | 5 | ◯ | ◯ | | 3 |

(Melting results: ◯ - excellent, Δ - moderate, X - crystallized or unmelted)
(Firing results: ◯ - excellent, Δ - moderate, X - crystallized or unflowable)

The glass samples 1 to 18 were melted for 30 minutes by heating in the air at 1100° C. using an electric furnace, and then quenched to prepare glass. As a result, as shown in Table 1, all the glass samples containing (P₂O₅+ZnO), V₂O₅ and TeO₂ were melted.

Subsequently, each of the samples 1 to 18 was processed into powder of 50 μm or smaller to prepare glass powder, which was heated at 500° C. and fired for 30 minutes. As a result, as shown in Table 1, firing was performed well and superior fluidity and physical properties were achieved for 50 to 65 mol % of (P₂O₅+ZnO), 30 to 45 mol % of V₂O₅, 5 to 20 mol % of TeO₂ and 1 or 3 mol % of Al₂O₃. The physical properties refer to the strength, chemical stability and adhesiveness of the glass.

In addition, superior firing results were achieved for the glass compositions with a V₂O₅/TeO₂ molar ratio of 2 to 6. Superior firing results mean satisfactory processing by firing with good melting, without crystallization.

The description hereinabove provided has described the technical spirit of the present disclosure for illustrative purposes only, and various modifications, changes and substitutions can be made by those skilled in the art without departing from the nature of the present disclosure. Accordingly, the embodiments disclosed herein are provided to describe, but not intended to limit the technical spirit of the present disclosure, and the scope of the technical spirit of the present disclosure is not limited by these embodiments. The scope of protection of the present disclosure should be interpreted by the appended claims, and the full technical spirit within the scope in equivalence thereto shall be interpreted as being included in the scope of protection of the present disclosure.

1. A glass composition for sealing a dye-sensitized solar cell, comprising (P₂O₅, +ZnO)—V₂O₅—TeO₂,
wherein
(P₂O₅+ZnO) are present in 50 to 65 mol %, V₂O₅ is present in 30 to 45 mol %, TeO₂ is present in 5 to 20 mol %,
V₂O₅/TeO₂ has a value of 2 to 6 based on a molar ratio, and
at least one selected from Al₂O₃, B₂O₃ and Sb₂O₃ is comprised in an amount more than 0 mol % and less than or equal to 10 mol %.

2. The glass composition for sealing a dye-sensitized solar cell according to claim 1, wherein the at least one selected from Al₂O₃, B₂O₃ and Sb₂O₃ partly replaces the (P₂O₅ +ZnO).

3. The glass composition for sealing a dye-sensitized solar cell according to claim 1, which has a firing temperature of 400 to 500° C.

4. A paste for sealing a dye-sensitized solar cell, comprising: the glass composition according to claim 1; and an organic vehicle.
